(19) United States
(12) Patent Application Publication
(10) Pub. No.: US 2014/0157522 A1
(43) Pub. Date: Jun. 12, 2014

(54) PORTABLE ELECTROMECHANICAL TOOL

(71) Applicant: Marcel Lorini, Brindas (FR)

(72) Inventor: Marcel Lorini, Brindas (FR)

(73) Assignee: MAGE APPLICATION, Claix (FR)

(21) Appl. No.: 14/233,525

(22) PCT Filed: Jul. 12, 2012
(86) PCT No.: PCT/FR2012/051658

§ 371 Date: Jan. 17, 2014

(30) Foreign Application Priority Data
Jul. 19, 2011 (FR) 1156551

(51) Int. Cl. H02G 1/00; B26B 15/00; B23D 29/02

(52) U.S. Cl. CPC H02G 1/005; B23D 29/023; B26B 15/00
USPC 7/107; 173/216; 30/228

(57) ABSTRACT

Portable electromechanical tool comprising a unit (2) enclosing a continuous current electric motor (23) powered by a storage battery (4), a mechanical reduction gear (25) driven by the output shaft of said motor, which activates a working head (3) by means of a device (40) for converting the rotary motion of the motor (23) into a longitudinal translation movement, which is transmitted to said working head (3). According to the invention, said converting device (40) comprises a planetary roller screw, said screw comprising a threaded part (41), which is driven in rotation by said reduction gear to transmit motion via planetary rollers (43) to a threaded nut (42) that drives a mobile part (5) of said working head (3) in translation.

### FIELD OF THE INVENTION

The present invention relates to a portable electromechanical tool of the type comprising a portable unit from which a head of the tool moved in relation to the unit by a battery-powered electric motor projects, said tool being suitable for performing cutting, crimping, separation, blanking operations, etc., more particularly operations requiring the application of significant forces.

### STATE OF THE RELATED ART

Such a tool may be a tool for crimping electrical cables required to exert a force of approximately six to twelve metric tons. The document FR 2 644 383 describes a tool for crimping electrical cables which is in the general form of a gun wherein the handle contains an electric motor and a reduction gear and wherein the body contains the storage battery and an oil chamber, along with a hydraulic motor projecting from the tool head. A control trigger is suitable for starting up the electric motor. Although functioning satisfactorily, it was nonetheless noted that the hydraulic drive of the tool involved problems in respect of tightness, degradation of the oil, tubes, giving rise to high tool maintenance costs.

The document U.S. Pat. No. 4,418,562 further discloses a portable electric compression or cutting tool comprising an electric motor coupled via a reduction gear with a pinion transmitting the movement to a power transmission wheel. Said wheel comprises an eccentric cam moving two pivoting jaws at the end of the tool. The tool further comprises an electronic circuit for controlling and protecting the motor in the case of overloads. The drawback of this tool is that the movement transmitted by the cam is relatively small, which limits the use of the tool with radial actuation pivoting jaw heads, giving rise to a relatively small opening range of the jaws thereof.

The document WO 2006/01847 describes a portable electromechanical tool suitable for greater tool head travel. The tool comprises an electric motor rotating a ball screw suitable for converting the rotary motion of the motor shaft into a longitudinal translation movement of the screw. As such a ball screw is suitable for developing a significant force, the tool is also provided with means for protecting the motor in the event of no-load operation. While being suitable for transmitting significant forces to the part subject to the action thereof, this tool involves limitations when a high rotational speed is to be applied to the screw or when a high positioning precision in respect of the tool head, or the moving parts thereof, is sought. Furthermore, the size of the transmission part of the tool is relatively large, which is detrimental for the general dimensions of a portable tool.

### AIM OF THE INVENTION

The aim of the invention is that of remedying at least in part these drawbacks and providing a portable electromechanical tool which is suitable for transmitting significant forces with high speeds and high accelerations of the tool head, for precise movement thereof, while having a small size and an increased tool service life.

A further aim of the invention is that of providing a heavy-duty portable electromechanical tool, having a satisfactory rigidity and a satisfactory shock resistance, while having a working head suitable for developing a significant stroke, very precisely.

A further aim of the invention is a portable electromechanical tool which has a lower weight than existing tools, which is suitable for running reliably over time, while being suitable for being manufactured economically in mass production.

A further aim of the invention is that of providing a portable electromechanical tool suitable for cutting potentially live electrical underground network cables quickly and efficiently, while being safe to operate for the personnel using same.

The aims are achieved with a portable electromechanical tool comprising a unit enclosing a direct current electric motor powered by a storage battery, a mechanical reduction gear driven by the output shaft of said motor, which activates a working head by means of a device for converting the rotary motion of the motor into a longitudinal translation movement, which is transmitted to said working head or to a moving part thereof, in that said converting device comprises a planetary roller screw, said screw comprising a threaded part which is rotated by said reduction gear to transmit motion via planetary rollers to a threaded nut that drives a moving part of said working head in translation.

The term converting device comprising a planetary roller screw refers to a device comprising a central screw having a multi-input outer thread, a nut concentric with the screw having an inner thread identical to that of the screw and a plurality of planetary rollers, arranged between the screw and the nut, each roller having a one-input outer thread, wherein the helix angle corresponds to that of the nut. In operation, by rotating the central screw and locking the nut in translation, a longitudinal translation movement thereof is obtained. According to the invention, the longitudinal translation movement of the nut actuates the working head, or a moving part thereof, and enables the transmission thereby of a given force, in a defined direction, with a given stroke, the transmitted movement optionally being reversible.

In this way, such a tool is portable and standalone, is suitable for converting the rotary motion of the electric drive motor into a longitudinal translation movement applied to the working head of the tool or to a moving part of the working head which, in turn, moves further elements of the working heads, such as cutting blades in a pivoting movement, while enabling the transmission of large forces, even when the screw rotates at a high speed or when high accelerations are applied thereto, for precise movement of the working head. Indeed, due to the design thereof, the static and dynamic load capacities of a planetary roller screw type mechanism are markedly superior to any other screw mechanism, particularly of the type comprising a ball screw. Furthermore, as the screw thread is not influenced by the ball diameter, it may be readily adapted to the target application, to obtain enhanced performances in respect of tool operation, particularly tool movement precision, and optimization of the dimensions thereof.

In this way, a tool suitable for developing a significant force, comparable to that of hydraulic drive tools, is obtained, with a lower tool weight and enhanced handling thereof, while doing away with the problems associated with a hydraulic drive, such as oil degradation, tool hydraulic circuit tightness, tube degradation, or risk of oil poisoning for the personnel using same.

Such a tool can be used in operations requiring simultaneous movement of the working head and application of a force to the object subject to the action of the tool, particularly to perform electrical cable or pipe crimping operations, plant cutting operations as carried out with clippers or pruners, operations for releasing or opening armored doors performed by the fire services to rescue people, tools for cutting electrical cables, such as potentially live underground network cables, and others.

Preferably, the rotary motion is transmitted by the mechanical reduction gear to a main shaft wherein one of the ends comprise a sprocket receiving the movement of a return pinion engaged with a driving pinion of said reduction gear, and said threaded part of the screw is embodied at the opposite end of said main shaft.

Such a return pinion drive is suitable for arranging in parallel, on one hand, the motor and the reduction gear thereof and, on the other, the main shaft and thus reducing the dimensions, particularly the length, of the tool.

Advantageously, the outer diameter of said threaded part is between 25 and 35 mm and comprises a threaded part with a triangular profile having a right pitch between 3 and 6 mm and five inputs.

It was observed that such a tool succeeded in transmitting significant forces to the moving part of the working head, while having a more compact size and a low weight.

In a preferred example of an embodiment of the invention, said moving part drives two moving blades with a circular profile in a rotary motion about an axis perpendicular to the longitudinal axis of said threaded part.

It is indeed possible to apply the translation movement of the moving part of the working head directly to the object subject to the action of the tool, as in the case of a compression or release tool. In one alternative embodiment of the invention, the translation movement of the moving part of the working head is applied to a hinged mechanism actuating, in a closing and opening movement, two blades of the working head. Such a tool may then advantageously be used for performing cutting operations on various objects arranged between the blades thereof.

Advantageously, one of the blades has a protruding cable crimper situated substantially at the center of said blade and connected to a grounding braid.

Such a tool is advantageously used for cutting electrical cables, such as underground network cables.

Preferably, the tool according to the invention comprises a positioning and locking device which is pivotably mounted, under the action of at least one return spring, along an axis parallel with the rotational axis of said blades.

Such a device is suitable for facilitating the insertion of the cables between the blades, ensuring the automatic locking thereof and facilitating the handling of the tool.

Advantageously, said blades are suitable for completing a stroke between 80 mm and 100 mm in around 60 seconds. Such a tool is thus suitable for performing cutting operations on large-diameter metal cables, developing high forces in relatively little time.

Preferably, the tool according to the invention comprises two inductive sensors for detecting the opening and closing position of the blades which are connected to an electronic board for controlling the electric motor. Such an electronic board is suitable for managing the operation of the tool easily.

Advantageously, said electronic board is embodied so as to be able to check and control the charging status of the storage battery before authorizing the start-up of the tool. This makes it possible to offer a movement at constant speed of the tool blades.

In one preferred alternative embodiment of the tool according to the invention, said tool comprises a device for the remote control of the electronic board. This enables safe use for the operator.

### DESCRIPTION OF THE FIGURES

FIG. 1 illustrates a perspective view of a portable electromechanical tool according to a preferred embodiment of the invention.

FIG. 2 illustrates an exploded perspective view of the portable electromechanical tool in FIG. 1.

FIG. 3 illustrates an axial sectional view of the electromechanical tool in FIG. 1.

List of references:

| | |
|---|---|
| 1 | Cable crimping and cutting tool |
| 2 | Unit |
| 3 | Working head |
| 4 | Battery |
| 5 | Moving part of working head |
| 7 | Junction |
| 8 | Lower blade |
| 9 | Upper blade |
| 10 | Cable crimper |
| 11 | Braid |
| 12 | Positioning and locking device |
| 13 | Pivoting axis |
| 14 | Cover |
| 15 | Return spring |
| 16 | Fixing lug |
| 17 | Transverse wall |
| 18 | Curved slot |
| 19 | Blade guide |
| 20 | Handle |
| 21 | Connector |
| 22 | Electronic board |
| 23 | Electric motor |
| 24 | Electric motor output shaft |
| 25 | Mechanical reduction gear |
| 24 | Reduction gear output shaft |
| 27 | Interface |
| 28 | Driving pinion |
| 29 | Return pinion |
| 30 | Sprocket |
| 31 | Main shaft |
| 32 | Protective cover |
| 33 | Ball bearings |
| 34 | Fixing bush |
| 35 | Cylindrical roller and thrust bearing |
| 36 | Cylindrical casing |
| 37 | Return pinion axis |
| 38 | Flange |
| 39 | Shoulder |
| 40 | Converting device |
| 41 | Threaded part |
| 42 | Threaded nut |
| 43 | Planetary rollers |
| 44 | Outer threaded part |
| 45 | Key |
| 46 | Cover body |
| 47 | Guiding bush |
| 48 | Front part |
| 49 | Cover |
| 50 | Transverse rod |
| 51 | Link |
| 52 | Axis |
| 53 | Trunnion |
| 54 | Ring |

### DETAILED DESCRIPTION OF THE INVENTION

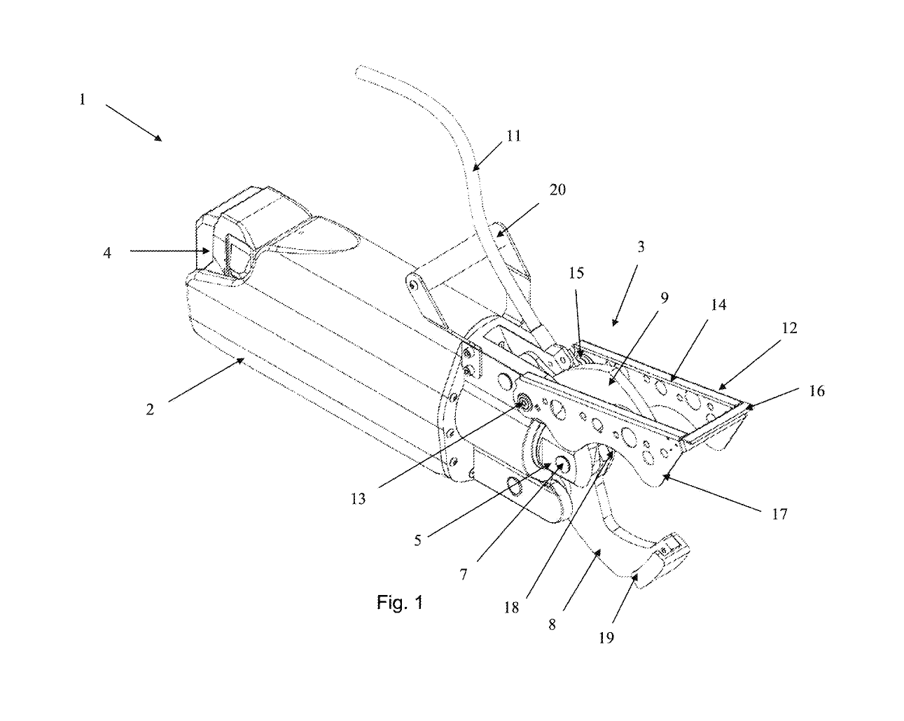

FIG. 1 illustrates a portable electromechanical tool according to a preferred embodiment of the invention which is a cable crimping and cutting tool 1 intended to cut electrical cables, for example potentially live low and medium voltage underground network cables, after previously crimping to ensure that no voltage is present on these cables. The tool 1 comprises a unit 2, having a general tapered tubular shape, provided with a working head 3 on the front end thereof and a battery 4 at the rear end thereof. The battery 4 is a removable rechargeable battery and supplies power to an electric motor provided to drive a moving part 5 of the working head 3 in translation, via a reduction gear and a movement converting device, as explained hereinafter.

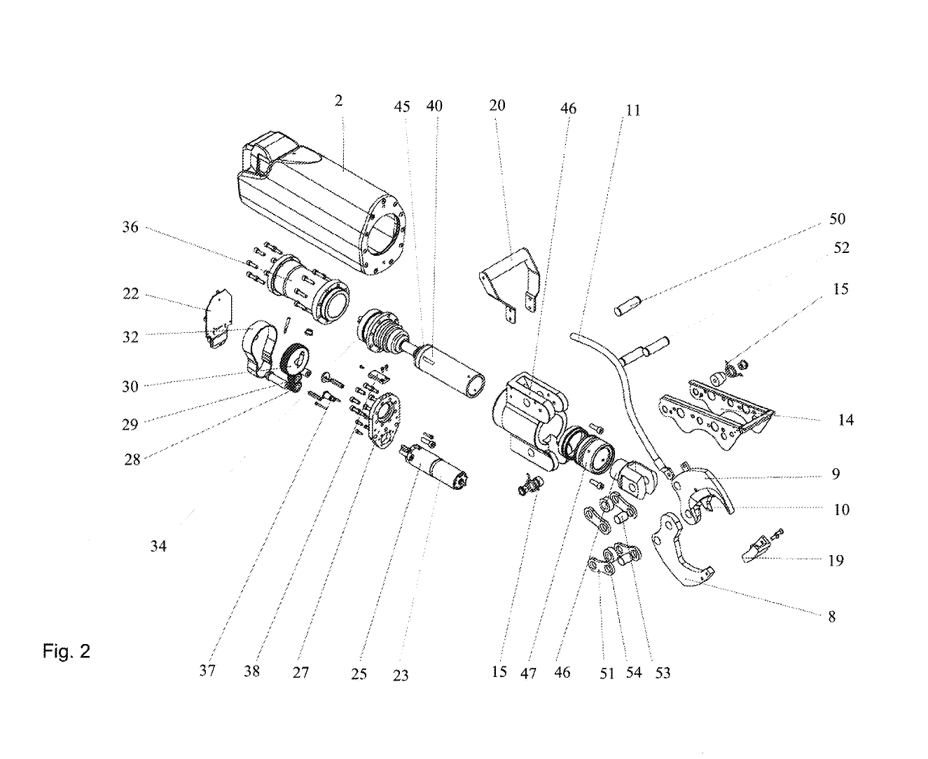

In the example represented in the appended figures, the moving part 5 comprises a front part supporting a hinge type pivoting junction 7 about which two cutting blades are mounted with rotary capabilities, particularly a lower blade 8 and an upper blade 9. At the center of the upper blade 9 a cutter referred to as a cable crimper 10 (FIG. 2) protrudes, connected, by means of a fixing lug, to a grounding braid 11. At the end of the lower blade 8, a blade guide 19 is attached, suitable for guiding the upper blade during the cutting movement thereof. The tool 1 also comprises a handle 20 for easier transport and handling of the tool 1.

The tool 1 also comprises an automatic positioning and locking device 12 in respect of the cables to be cut consisting of a cover 14 capable of pivoting, under the force of two return springs 15, about an axis 13 perpendicular to the longitudinal axis of the tool 1. The cover 14 has, as seen from above, a general U shape encompassing the blades 8, 9 and wherein the base forming the front part of the cover 14 comprises a fixing lug 16 enabling the user to lift the cover 14 with a view to inserting the cable to be cut between the blades. The cover 14 has, on the sides of the transverse walls 17, a curved slot 18 suitable for holding the cable to be cut in position in the tool 1. The cover 14 is also suitable for locking the cable to be cut, the cover being held in the normally closed position by the return springs 15.

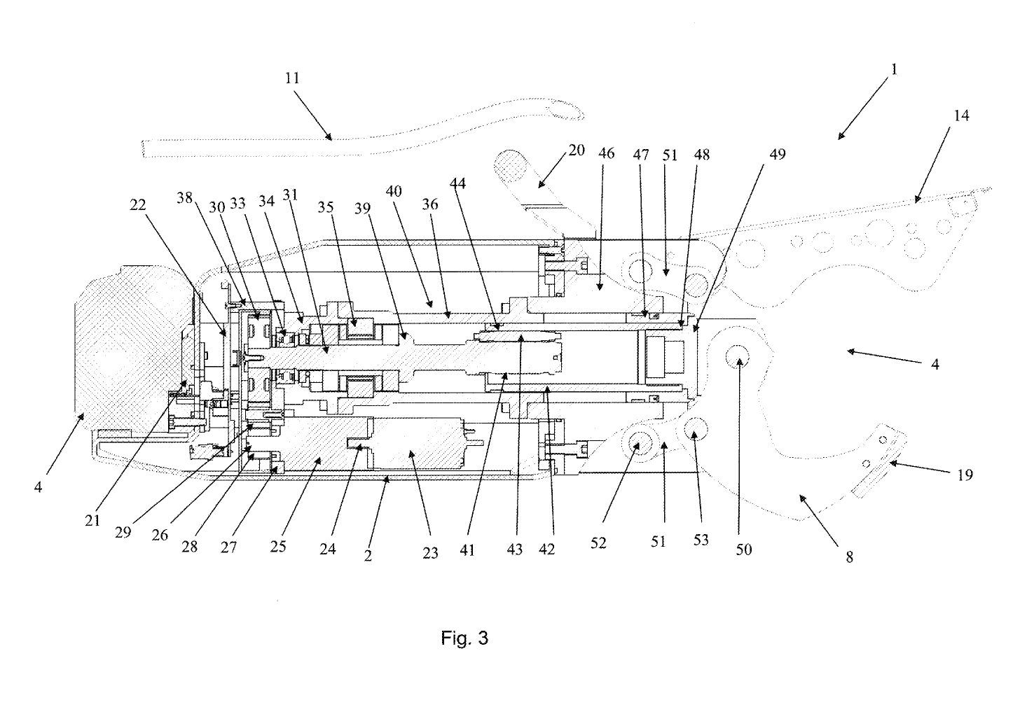

The various components of the tool 1 can be seen more clearly in FIG. 3. In this way, the unit 2 ends at the rear end thereof with a battery connector 21 comprising connection blocks with those of the battery 4. The battery 4 is rechargeable and removable, and, for example, it may be of the Li-ion type and have a voltage of 25.2 V. The battery 4 powers an electronic board 22 for controlling and operating the tool and supplies electricity to a direct current electric motor 23. The output shaft 24 of the electric motor rotates a mechanical reduction gear 25.

The electronic board 22 manages the operation of the tool 1 while performing the functions for: controlling the motor for closing and opening the blades, monitoring and stabilizing the speed of the motor 23 at a predefined set-point value, monitoring the position of the blades 8, to determine the end of the cutting operation, monitoring and displaying the status of the battery 4 in order to assess whether the battery can supply sufficient power to start a cable crimping and cutting operation and subsequently decide to start the operation or replace the battery, or recharge same, and, optionally, communication with a two-way radio receiver for the remote control of the tool.

For example, such a motor 23 is powered at a voltage of 24 V, at a power of approximately 200 W and a diameter of approximately 40 mm and is suitable for operating in both directions of rotation. The reduction gear according to the invention should be capable of supplying the mechanical power for a high mechanical torque and a reduced speed. For example, the reduction gear 25 according to the invention supplies a torque between 3 and 15 Nm and has a diameter of approximately 42 mm.

The motor 23 and the reduction gear 25 are supported by an interface 27 attached to the inside of the unit 2. The electronic board 22 is mounted by means of a flange 38 and fixing screws onto the interface 27. The output shaft 26 of the reduction gear 25 rotates a driving pinion 28 secured thereon, the driving pinion rotating, via a return pinion 29 borne by a return shaft 37 supported by the interface 27, a sprocket 30 of a main shaft 31 included in a converting device 40. A protective cover 32 is secured on the interface 27 and is suitable for containing the pinions 28, 29, 30 in a confined space.

The role of the converting device 40 is that of converting the rotary motion of the main shaft 31 into a translation movement of a threaded nut 42 positioned around and coaxial with the main shaft 31.

The main shaft 31 comprises a first support zone in the tool, extending along approximately half the length thereof, it is comprised between the rear end thereof and a shoulder 39; along with a second active zone comprising a threaded part 41 extending along at least half of the length of the active zone, from the front end of the main shaft 31. The main shaft 31 is supported on ball bearing blocks 33 in a bush 34 used for fixing to the interface 27 and on cylindrical roller and axial thrust bearings 35 inside a cylindrical casing 36. The cylindrical casing 36 comprises at the rear end thereof a flange whereby it is secured by fixing screws (FIG. 2) to the flange corresponding to the fixing bush 34.

According to the invention, the threaded part 41 of the main shaft 31 transmits the rotary motion to the threaded nut 42 by means of the planetary rollers 43. The planetary rollers 43 are positioned longitudinally between the main shaft 31 and the threaded nut 42 and have an outer thread engaged with the thread of the threaded part 41 of the shaft 31 and with the thread of said threaded nut. The planetary rollers 43 also have at each of the ends thereof gear teeth engaging with the gear teeth of the threaded part 41 to prevent any longitudinal shift between the two and thus synchronize the planetary rollers together.

In the example shown in the figures, the threaded nut 42 has an outer diameter of 70 mm, a threaded inner part having a diameter of 49.76 mm and a length of approximately 34 mm. The threaded inner part of the nut 42 has a 5 mm right pitch with five inputs. For the purpose of clarity in the figures, a single planetary roller 43 has been shown in FIG. 3; however, in the example illustrated in the appended figures, five planetary rollers transmit the movement between the shaft 31 and the nut 42. Each roller has an outer threaded part 44 extending along a length of approximately 30 mm, for a diameter of 12 mm, a pitch of 1 mm, and has a single input. The threaded part 41 of the main shaft 31 has a length of approximately 100 mm, a diameter of approximately 27 mm, a right pitch of 5 mm with 5 inputs. The thread is triangular and has an angle at the top of 90°.

The threaded nut 42 has means for locking in rotation embodied in the form of two keys 45 inserted into corresponding ducts (not shown in the figures) created in the walls of the cylindrical casing 35. In this way, during the rotation of the main shaft 31, the threaded part 41 thereof rotates the planetary rollers 43 engaged with the threaded nut 42 which, locked in rotation, performs a longitudinal translation movement along the longitudinal axis of the main shaft 31.

The threaded nut 42 is guided in the translation movement thereof inside a cover body 46 by a guiding bush 47 secured at the front end 48 of the threaded nut 42. A cover 49 is secured by screwing inside the front part 48 and is suitable for rigidly connecting the nut 42 in movement. The cover 49 supports in the central part thereof a fixedly mounted transverse rod 50 with respect to the cover 49 and arranged perpendicular to the main axis 31. The lower 8 and upper 9 blades are mounted with rotary capabilities about the transverse rod 50.

The lower 8 and upper 9 blades have a general arc shape, they are rotated about the axis of the transverse rod 50 and about the axis of a trunnion 53 of a mounting assembly to the cover body 46. The mounting assembly of each blade to the cover body 46 comprises two links 51 separated by a ring 54 which are pivotably mounted, at the rear end thereof, about a transverse axis 52 in relation to the longitudinal axis of the cover body 46 and, at the front end thereof, support the axis of the trunnion 53. In operation, the alternative longitudinal translation movement applied to the cover 49 induces a rotary movement of the blades 8 and 9 about the axis of the transverse rod 50 and thus the closure and opening of the blades 8, 9.

The blades 8, 9 are preferably made of treated steel and the arc shape thereof enables satisfactory centering of the cables to be cut following the positioning thereof in the tool. In the example shown in the figures, the blades are designed such that the shapes and dimensions thereof are suitable for correctly centering, and cutting, cables having diameters between 20 mm and 90 mm.

For example, such a tool has dimensions 715×290×130 mm (understood to be length×height×width) and a weight of approximately 15 kg. It can develop a force of approximately 80 kN and complete a stroke between 80 mm and 100 mm in approximately 60 seconds.

In operation, the electronic board of the motor starts by checking the status of the battery 4 to ensure that the battery is charged and that it can supply the motor 23 with power. The blades being in the opening position, the electrical cable to be cut is inserted, after previously raising the cover 14 of the positioning device 12. Once released, the cover 14 pushed by the springs 15 automatically positions the cable to be cut correctly between the blades. The closing movement of the blades 8, 9 may then be actuated.

During the closing movement of the blades 8, 9, the cable crimper 10 rigidly connected to the upper blade 9 is the first to come into contact with the cable to be cut. The cable crimper 10 makes it possible to ensure that there is no voltage on the isolated underground network cables, by limiting the crimping of a multi-pole cable to a single-phase fault, thus enabling the activation of the safety devices situated upstream, before producing a two-phase or three-phase short-circuit. The design of the working head 4, particularly the profile of the blades 8, 9 and the design and arrangement of the cable crimper 10, is embodied such that the time interval between the time when the cable crimper 10 is in contact with the first phase and when it reaches the second phase should be at least equal to 1.2 s, regardless of the type of multi-pole cable. In this way, the network protections may react before one of the blades 8, 9 has reached a second phase.

In one alternative embodiment of the invention, the electronic board 22 actuates the shutdown of the electric motor 23 for a time interval when the crimping takes place on a live phase.

The complete closing movement of the blades 8, 9 continues to cut the cable. Then, the blades 8, 9 are actuated for opening, the tool being thus ready for another operation.

Preferably, the tool 1 according to the invention comprises two end of travel inductive sensors, particularly a first inductive sensor for detecting the opening position of the blades and a second inductive sensor for detecting the closing position of the blades. These sensors are positioned on the cylindrical casing 36 and are suitable for supplying the axial position of the threaded nut 42 to the electronic board 22. According to the information received from these sensors, the electronic board controls the direction of rotation of the electric motor 23 to open or close the blades.

In one preferred alternative embodiment of the invention, the tool 1 is remote controlled, by means of a remote control, having for example a range of 20 m, enabling the operator to work remotely in completely safety. Such a remote control may comprise push buttons for controlling the power supply of the electric motor and the direction, to open or close the blades.

Further alternative embodiments and embodiments of the invention may be envisaged without leaving the scope of the claims.

1. Portable electromechanical tool comprising a unit (2) enclosing a direct current electric motor (23) powered by a storage battery (4), a mechanical reduction gear (25) driven by the output shaft of said motor, which activates a working head (3) by means of a device (40) for converting the rotary motion of the motor (23) into a longitudinal translation movement, which is transmitted to said working head (3), characterized in that said converting device (40) comprises a planetary roller screw, said screw comprising a threaded part (41) which is rotated by said reduction gear to transmit motion via planetary rollers (43) to a threaded nut (42) that drives a moving part (5) of said working head (3) in translation.

2. Tool according to claim 1, characterized in that the rotary motion is transmitted by the mechanical reduction gear (25) to a main shaft (31) wherein one of the ends comprises a sprocket (30) receiving the movement of a return pinion (29) engaged with a driving pinion (28) of said reduction gear, and in that said threaded part (41) of the screw is embodied at the opposite end of said main shaft (31).

3. Tool according to claim 1, characterized in that the outer diameter of said threaded part (41) is between 25 and 35 mm and comprises a threaded part with a triangular profile having a right pitch between 3 and 6 mm and five inputs.

4. Tool according to claim 1, characterized in that said moving part (5) drives two moving blades (8, 9) with a circular profile in a rotary motion about an axis perpendicular to the longitudinal axis of said threaded part (41).

5. Tool according to claim 4, characterized in that one of the blades (8, 9) has a protruding cable crimper (10) situated substantially at the center of said blade and connected to a grounding braid.

6. Cable crimping and cutting tool according to claim 4, characterized in that it comprises a positioning and locking device (12) which is pivotably mounted, under the action of at least one return spring (15), along an axis parallel with the rotational axis of said blades (8, 9).

7. Tool according to claim 4, characterized in that said blades (8, 9) are suitable for completing a stroke between 80 mm and 100 mm in around 60 seconds.

8. Tool according to claim 4, characterized in that it comprises two inductive sensors situated on said unit (2) for detecting the opening and closing position of the blades (8, 9) which are connected to an electronic board (22) for controlling the electric motor (23).

9. Tool according to claim 8, characterized in that said electronic board (22) is embodied so as to be able to check and control the charging status of the storage battery (4) before authorizing the start-up of the tool.

10. Tool according to claim 8, characterized in that it comprises a device for the remote control of the electronic board (22).
